(19) United States
(12) Patent Application Publication
(10) Pub. No.: US 2010/0199828 A1
(43) Pub. Date: Aug. 12, 2010

(54) SEPARATION DEVICE FOR SHEARING OFF WORK PIECES LINED UP IN ROWS ON A SUPPLY TAPE

(75) Inventor: Robert Adkins, Warren, OH (US)

Correspondence Address: MAYER & WILLIAMS PC, 251 NORTH AVENUE WEST, 2ND FLOOR, WESTFIELD, NJ, 07090, US

(73) Assignee: RENNSTEIG WERKZEUGE GMBH, Vernau (DE)

(21) Appl. No.: 12/421,504

(22) Filed: Apr. 9, 2009

(30) Foreign Application Priority Data
Feb. 9, 2009 (DE) 20 2009 001 625.0

(51) Int. Cl. B26D 1/00

(52) U.S. Cl. 83/697

(57) ABSTRACT

The present invention provides a separation device for shearing off work pieces lined up on a supply tape, especially crimp contacts. The device is of a simple design, inexpensive to manufacture, and is especially suited for use at the site where the crimp connections are produced. In the process, it is possible to use ordinary crimping tools as the driving elements for the separating device. In one embodiment, the device includes upper and lower crimping jaws that are placed opposite each other and which form a crimping bit. As with all other pliers, the two crimping jaws can be moved between an open and a closed position, whereby it is not to be understood by the closed position that the crimping jaws of necessity must touch. On the lower jaw, a supporting beam is attached, which has a resting surface to place the work piece and/or supply tape on during the separation process, and a first shearing edge. When the work piece is placed on, the first shearing edge is aligned with an imaginary separation line, along which the work piece is to be sheared off the supply tape.

### BACKGROUND OF THE INVENTION

The present invention relates to a separation device for shearing off work pieces lined up on a supply tape, especially electrical crimp contacts.

Electrical crimp contacts and comparable work pieces, smaller ones for the most part, which are made in one-piece fashion from light metal for example, are lined up during manufacturing on a supply tape for easier manipulation. During the manufacturing process, such work pieces are processed out from a tape material, for example through stamping and subsequent bending. In the process, a connection remains via a web to an “endless” supply tape. Lining them up on a supply tape is especially advantageous, if, after mechanical processing, surface refining or some other further processing is to be done on the work pieces. Small electrical-technology parts may for example be subject to galvanic coating with silver or gold, with the supply tape and the work pieces lined up on it being continuously moved by discontinuous steps through galvanic baths.

Such work pieces are electrical crimp contacts, which may be embodied as adapter plugs, cable shoes, plugs, or multi-core cable ends. Customarily, crimp contacts exhibit a section for manufacture of the electrical connection with a cable, the electrical crimp, an at least one additional section for mechanical connection with the insulation of the adjoining cable, the insulation crimp. Crimp contacts available as tape goods are cheaper for the most part and are easier to manipulate during the processing that follows. It is necessary, however, to separate the crimp contacts as part of the attachment of the particular cable ends at the latest. Mechanical devices can be used to separate larger numbers of pieces, which however are expensive and available mostly in larger fabrication areas only.

From DE 82 29 289 U1 a crimping machine is known which can process contacts that are connected in tape fashion. For this, a feeding device is provided with a feed channel and a transporting latch that engages into it.

DE 10 2007 024 543 describes a device for separating work pieces that are placed transversely on a tape. Provided for this are a separating unit with a first roll, a cranking unit with a second roll, a separating knife and a guiding unit to guide the tape. The cranking unit is positioned tangentially opposite the cutting unit, so that the cutting knife rolls away on the opposite unit when the cranking unit turns, to cut the work pieces from the tape. The design of this device remains relatively complex. To use the device, appropriate spatial conditions are required, such as setting aside and attaching a device onto a workbench. The device is less suited to mobile use, since it must be brought along in addition to the required crimping tools as it is.

### SUMMARY OF THE INVENTION

Thus the task of the present invention consists in making available a separation device for shearing off work pieces lined up on a supply tape, especially crimp contacts, that is of a simple design, inexpensive to manufacture, and is especially suited for use at the site where the crimp connections are produced. In the process, it especially should be possible to use ordinary crimping tools as the driving elements for the separating device.

This problem is solved by a separating device according to the appended claim 1.

The separating device comprises upper and lower crimping jaws that are placed opposite each other and form a crimping bit. As with all other pliers, the two crimping jaws can be moved between an open and a closed position, whereby it is not to be understood by the closed position that the crimping jaws of necessity must touch. On the lower jaw, a supporting beam is attached, which has a resting surface to place the work piece and/or supply tape on during the separation process, and a first shearing edge. When the work piece is placed on, the first shearing edge is aligned with an imaginary separation line, along which the work piece is to be sheared off the supply tape. Additionally, the separation device comprises a stamp, which at least when the shearing-off takes place, is coupled by gravity to the upper crimping jaw and to a second shearing edge. When the crimping jaws are in the open position, the second shearing edge is above the separation line, while during the transition into the closed position, they pass by the first shearing edge, to shear off the working piece from the supply tape. Finally, a stop surface is present, at which the work piece and/or the supply tape are impacted so that the shearing edges carry out the separating process exactly along the separation line. The stop surface can be placed both on the support beam and on the stamp.

An important advantage of the invention-specific separating device consists in its being usable for various crimp contacts, and permitting mobile use, since it can especially be attached to manual pliers. With this it is possible, instead of a crimping die, to attach a crimping tool detachably on the jaws of a crimping tool, through which the user has a possibility of performing a separation of the crimp contacts with one and the same tool, to then attach the appropriate crimping die onto the tool and carry out the crimping process.

A first embodiment form of the separating device has a long extended carrying beam with a carrying surface essentially extending over the entire length of the carrying beam, on which multiple work pieces or crimp contacts can be positioned simultaneously. The first shearing edge runs in the longitudinal direction of the carrying beam, parallel to the carrying surface, which the second shearing edge essentially is of the same length and runs along the stamp, which likewise has a long extension. In addition, the stamp has a groove to admit the supply tape, whereby the opening edge of this groove directed toward the upper jaw of the pliers simultaneously forms the second shearing edge. This embodiment form is especially suited for simultaneously separating numerous small crimp contacts. Because the material is not thick, sufficiently great force can be applied using a manual tool to separate multiple crimp contacts in a common shearing process from the supply tape. A varied embodiment form is distinguished in that when the tool jaws are closed, the two shear edges meet over their entire length at an acute angle, as is also the case with other cutters. The crimp contacts lined up on the supply tape are taken hold of in this way one after the other by the shearing edges and cut off, so that the force applied by the user is less than if all work pieces placed on the contact surface had to be cut through from the shearing edges at exactly the same moment. For example, this can be implemented through a second shearing edge that runs at an angle to the first shearing edge on the stamp, or by a stamp attached at an angle.

It is especially advantageous if the previously named embodiment form is configured so that the stamp is placed so it can be slid vertically into a stamp recess in the carrying beam. In this manner, the overall separating device obtains a compact design, so that pliers can be applied with few manual grips, without making it necessary to adjust individual component parts of the separating device to each other. For improved application of pliers force, a compression plate can be situated on the upperjaw, which is brought into contact with a compression surface on the stamp during the shearing off, without necessitating a secure, form-locking connection between the upper jaw and the stamp.

Preferably the stop surface is located on the stamp, immediately adjoining the second shearing edge. In addition, a pressing fin can be present, which is able to be pivoted to the numerous work pieces when the supply tape is inserted into the groove running in the stamp, by which the work pieces are compressed against the stop surface. By this means, the work pieces are positioned exactly to the shearing edges, thus ensuring a shearing off along the desired line of separation.

An altered embodiment form of the separating device possesses a carrying beam that is in the form of a receiving pocket adapted to the shape of a contact section of a single crimp contact, or of several smaller crimp contacts. In this case, the shearing edges run transverse to the longitudinal axis of the supply tape, and are likewise formed by a pair of shearing edge sections at an interval to each other. Two contact surfaces lie outside the receiving pocket and each starts at one of the shear edge sections and runs in the direction of the supply tape, which extends between the crimp contacts. The stop surface runs transverse to the first shear edge, and the stamp is attached to the upper jaw. This embodiment form is especially suited for separating large crimp contacts with a greater thickness of material.

### BRIEF DESCRIPTION OF THE DRAWINGS

Further advantages, particular features and additional embodiments of the present invention are derived from the following specification of preferred embodiment forms, with reference to the drawings. Shown are:

FIG. 1 is a perspective view of an invention-specific separating device according to a first embodiment form;

FIG. 2 is an exploded-view drawing of the embodiment form as per FIG. 1;

FIG. 3 is a side view of the embodiment forms shown in FIGS. 1 and 2;

FIG. 4 is a perspective view of a second embodiment form of the separating device in an opened position;

FIG. 5 is a side view of the embodiment form as per FIG. 4 in a closed position, with an inserted crimp contact;

FIG. 6 is a top-down view of the embodiment form shown in FIGS. 4 and 5 with an inserted crimp contact and additional crimp contacts lined up on a supply tape.

### DETAILED DESCRIPTION

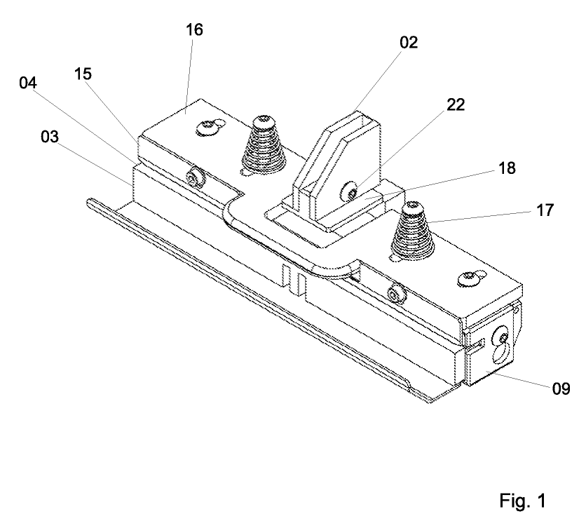

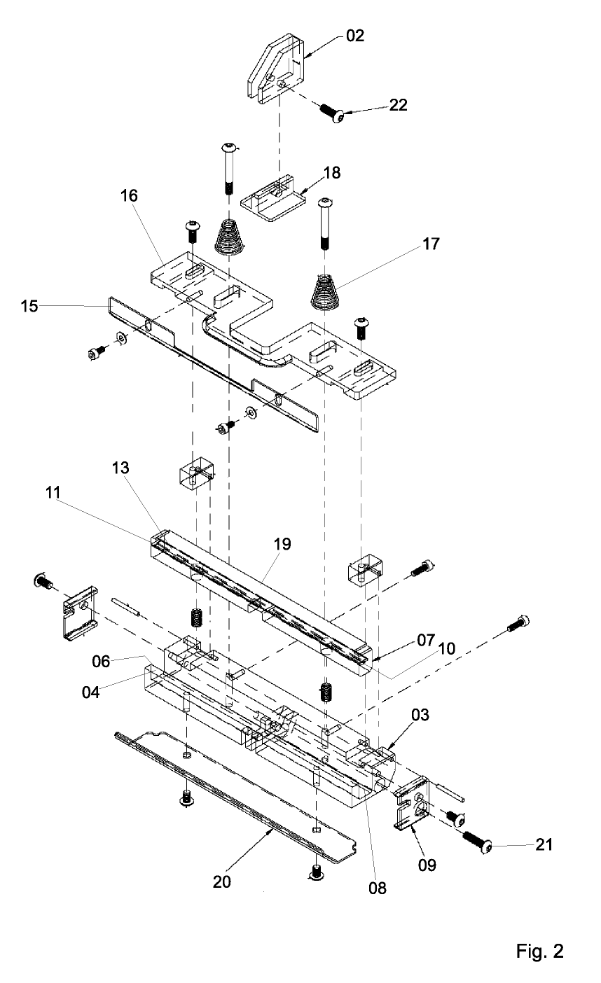

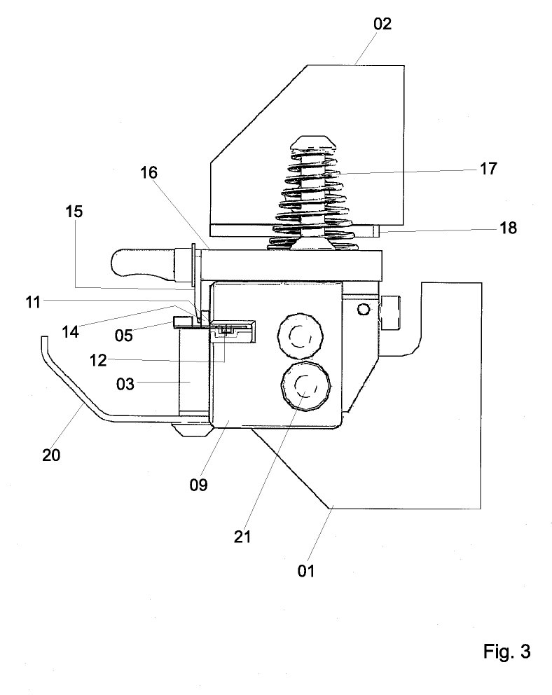

In FIGS. 1 to 3, a first embodiment form of an invention-specific separating device is shown in various views. The particular features, and their functions, are described as follows with simultaneous reference to these figures.

The separating device is configured for attachment onto a vice, which, in a manner known per se, has a lowerjaw 01 and an upperjaw 02. The jaws 01, 02 form a vice mouth, and can be moved, preferably in parallel, between a closed position and an open position. In the simplest case, the jaws 01, 02 are components of a manual vice, in which, in place of the crimping die, the separating device is used. Likewise, it is possible to integrate the jaws 01, 02 into a stationary device, which can be operated manually via a lever device or automatically via electric motors, pneumatic or hydraulic drives.

The separating device comprises a supporting beam 03, which can be attached on the lower jaw 01. The supporting beam 03 forms a support surface 04 on which numerous crimp contacts 05 can be positioned to lie next to each other. In the example depicted, the contact surface 04 is configured to be one piece with the supporting beam 03, but it can be formed by a component attached onto the supporting beam, which can be adapted to the special shaping of the crimp contacts.

The inward-facing longitudinal edge of the contact surface 04 is embodied as a first shearing edge 06. The first shearing edge 06 can be ground for a facilitated separation procedure, and should consist of hard material, to avoid a deformation when separating through the crimp contact material.

The separating device additionally comprises a stamp 07, which is impinged on by a pressurizing force during the shearing off, which is applied via the upper jaw 02. In the embodiment form shown in FIGS. 1 to 3, the stamp 07 is placed in a stamp recess 08 in supporting beam 03, and secured against shifting in the longitudinal direction by a side plate 09. The stamp recess 08 is made as a groove in supporting beam 03 and permits the stamp 07 to shift vertically, perpendicular to its longitudinal direction. In stamp 07 runs a groove 10 in the longitudinal direction, whose opening cross section also continues through the side plates 09. The opening edge of groove 10 directed toward the upper jaw 02 forms a second shear edge 11. The cross section of groove 10 is adapted to a supply tape 12, on which the crimping contacts 05 are lined up. The supply tape 12 can be threaded both in the opened position of the vice through the side plates 09 into the groove 10, and also from the front side via the contact surface 04. The surface of stamp 07 that adjoins the second shearing edge 11 in the opening plane of groove 10 forms a stop surface 13, on which, for example, an insulation crimp 14 of crimp contact 05 abuts, when the crimp contacts are positioned on the contact surface.

Especially with supporting beams with longitudinal extensions of more than 5 cm, it is appropriate to securely position the crimp contacts before the start of the shearing process on the stop surface 13. Serving as that, with the depicted embodiment form, is a pressing fin 15 that engages behind the insulation crimp 14 and pushes the crimp contacts and the supply tape found on them into the groove 10, until the insulation crimp adjoins on the stop surface 13. The pressing fin 15 is attached onto a retaining plate 16, which in turn is attached onto the supporting beam 03, and is held in position by compression springs 17.

To shear off the crimp contacts 05 from the supply tape 12, the stamp 07 must be moved downward in the stamp recess 08, whereby the second shearing edge 11 moves past the first shearing edge 06 and in the process cuts off the material between the crimp contacts and the supply tape along a separation line. Normally the crimp contacts 05 are attached via narrow ribs on the supply tape 12, so that it is appropriate to position the crimp contacts so that the separation line runs through these ribs. To apply the required shearing force, the mouth of the pliers is closed, through which a pressing plate 18 attached on the upper jaw 02 is pressed onto an underlying compression surface 19 on supporting beam 03. The vice stroke can for example limited by the pressing plate 18 impacting on the support beam 03 after the stamp 07 is sufficiently displaced.

To capture the separated crimp contacts, with the embodiment form depicted, a trapping pan 20 is attached onto the carrying beam 03, into which the crimp contacts fall, as soon as they are separated from the supply tape. The overall separating device can be removed from a vice by loosening a first attachment screw 21 from the lower jaw 01, to remove the carrying beam 03 and all components attached thereon. By loosening a second attachment screw 22 from the upper jaw 02, the pressing plate 18 can likewise be removed from the vice. The vice can then be equipped with whatever crimping dies which are not depicted, and be used as a crimping tool.

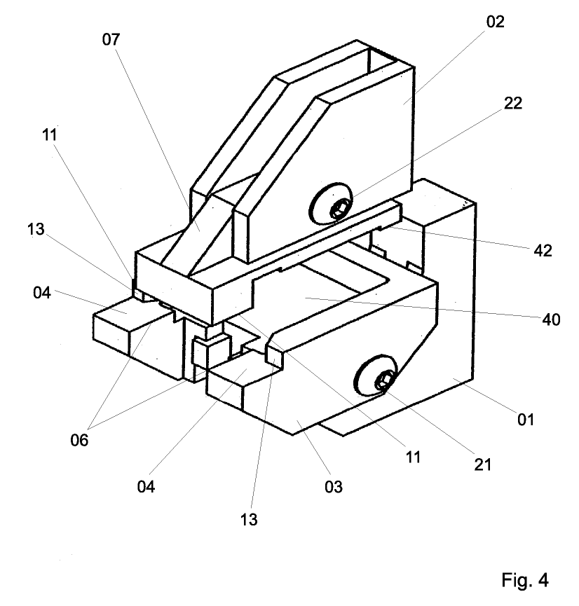

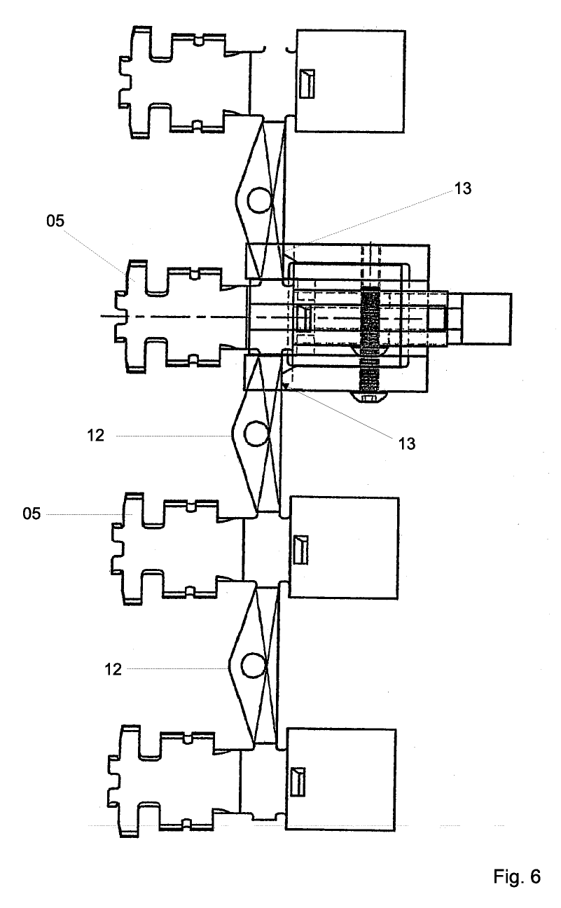

A second fundamental embodiment form of the separating device is depicted in FIGS. 4 to 6, and is described as follows while simultaneously making reference to these figures.

One essential difference from the above-described embodiment form consists in the measurements of the separating device being kept considerably smaller, since in a single separating pass, multiple work pieces or crimp contacts are not to be separated from the supply tape simultaneously, but rather just a single crimp contact is cut from the supply tape per working stroke. This embodiment form is also suited for large crimp contacts in which stronger forces are required to cut through the connections to the supply tape.

With this embodiment form, the carrying beam 03 has a receiving pocket 40, that preferably is positioned in the opening between the two vice jaws 01, 02. The receiving pocket 40 embraces a contact section 41 of crimp contact 05, for example from three sides, and is open in the direction turned away from the jaw, to allow the other sections of the crimp contact to emerge.

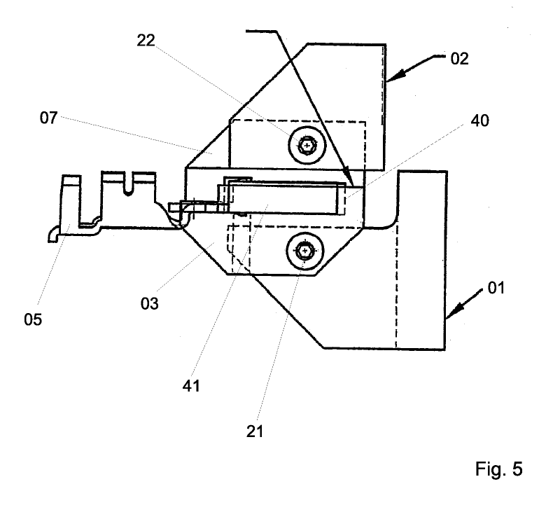

With this embodiment form, the shear edges run transverse to the longitudinal axis of the supply tape 12. The first shear edge 06 is formed by a pair of shear edge sections placed at an interval to each other and shaped in turn on the support beam 03 as sharp body edges. The stamp attached to the upper vice jaw 02 is moved when the vice is closed in the direction of carrying beam 03, and in the process presses contact section 41 into receiving pocket 40, as is evident from FIG. 5. Before the separating process, to the right and left of crimp contact 05, sections of the supply tape 12 lie on lateral contact surfaces 04, whose body edges facing each other form the two sections of the first shear edge 06. This embodiment form of the separating device thus is suited for separating crimp contacts or similar work pieces, in which the supply tape does not extend on the front side of the individual crimp contacts, but rather runs in the form of connecting ribs between the crimp contacts.

Onto stamp 07 in turn the second shear edge 11 is attached, which likewise is formed from two oppositely placed shear edge sections. During shearing along the two separation lines between the crimp contact 05 and supply tape 12 adjoining to the left and right, the crimp contact 05 is pressed downward, while the sheared-off supply tape stays on contact surface 04. To correctly position the crimp contact in the axial direction, two stop surfaces 13 are provided on support beam 03, on which the two lateral sections of supply tape 12 are placed, when the crimp contact is inserted into the separating device. So that, when separated, the crimp contact can swerve downward and not be deformed by action of the compression force exerted by stamp 07, the floor surface of receiving pocket 40 is lower than the contact surfaces 04 at least by the material thickness of supply tape 12.

To be able to run the separating device again on a traditional crimping tool, the support beam 03 and the stamp 07 are attached to each of the jaws 01, 02 using attachment screws 21, 22. The stroke of the stamp is limited by a stop 42 on the underside of the stamp 07, which strikes support beam 03 in the closed position.

The specialist will realize that the separating device can be adapted to various work pieces and crimp contacts in regard to its shaping. For medium-size contacts, it is also possible to place multiple separating devices according to the described second embodiment form next to each other and couple them to a common operating device.

1. A separating device for shearing off work pieces lined up next to each other on a supply tape, especially electrical crimp contacts, for use in a vice whose jaws can be moved between an open and a closed position, comprising:
a supporting beam attachable to a lower jaw, which has a contact surface for supporting the work piece and/or the supply tape and a first shearing edge which is aligned with a separation line when the work piece or supply tape is placed on, along which the work piece is to be separated from the supply tape;
a tensionally connected stamp able to be coupled onto an upperjaw with a second shearing edge, that lies above the separation line in the opened position and moves past the first shearing edge when in transition into the closed position, to shear the work piece off the supply tape;
a stop surface on which the work piece and/or the supply tape makes impact, to align the separation line with the shearing edges before shearing off.

2. The separating device according to claim 1, wherein:
the carrying beam has a contact surface that is long-extended, on which multiple work pieces can be positioned simultaneously;
the shearing edges run in the longitudinal direction of the contact surface;
the stamp has a groove to receive the supply tape, whose opening edge directed toward the upper jaw forms the second shearing edge.

3. The separating device according to claim 2, wherein the stamp is movably placed in a stamp recess in carrying beam perpendicular to its longitudinal axis.

4. The separation device according to claim 3, wherein onto the upperjaw a pressing plate is attached, which, for shearing off, is brought into contact with a compression surface of the stamp, and is at an interval from the compression surface in the opened position.

5. The separating device according to claim 4, wherein instead of a crimping die, the pressing plate and the carrying beam are detachably connected to a vice usable as a crimping tool.

6. The separating device according to claim 2, wherein a profiling is worked into the groove which is complementary to the profiling of the supply tape.

7. The separating device according to claim 2, wherein the stop surface is formed by the surface section of the stamp adjoining the two shearing edges, and that a compression rib is provided, which, after insertion of the supply tape into the groove of the stamp is pivotable on the work piece, to force it against the stop surface.

8. The separating device according to claim 7, wherein the compression rib is attached in spring-loaded fashion to the support beam.

9. The separating device according to claim 2, wherein when in a transition into the closed position, the two shearing edges make shearing contact with each other at an acute angle.

10. The separating device according to claim 2, wherein on the supporting beam a trapping pan is attached, into which the sheared-off work pieces fall.

11. The separating device according to claim 1, wherein:
the supporting beam has a receiving pocket that is adapted to the shape of a contact section of an individual crimp contact;
the shearing edges run transverse to the longitudinal axis of the supply tape;
both shearing edges are formed by a pair of shearing edge sections placed at an interval from each other;
two contact surfaces lie outside the receiving pocket and they both start at a first shearing edge section and run in the direction of the supply tape;
the stop surface runs transverse to the first shearing edge;
the stamp is attached to the upper jaw.

12. The separating device according to claim 11, wherein a stop surface is assigned to each contact surface.

13. The separating device according to claim 11, wherein the floor surface of the receiving pocket in the direction of the lower jaw is lower than the contact surface by at least the material thickness of the supply tape.

14. The separating device according to claim 11, wherein the stamp is attached on the upper jaw and the supporting beam on the lower jaw instead of a two-piece crimping die.
